(19) United States
(12) Patent Application Publication
(10) Pub. No.: US 2005/0026122 A1
(43) Pub. Date: Feb. 3, 2005

(54) Rosary mystery beads

(75) Inventor: Lisbeth Mary House, Orlando, FL (US)

Correspondence Address: LISBETH HOUSE, 4433 WINDERWOOD CIRCLE, ORLANDO, FL, 32835, US

(73) Assignee: Mary Agnes House

(21) Appl. No.: 10/880,227

(22) Filed: Jun. 29, 2004

Related U.S. Application Data
(60) Provisional application No. 60/487,233, filed on Jul. 16, 2003.

(51) Int. Cl. A44C 23/00; G09B 19/00

(52) U.S. Cl. 434/246

(57) ABSTRACT

What is new in the art to which my invention pertains is the idea that the mysteries of the rosary are actually printed on beads themselves. Rosaries are just made of beads, with the person relying upon a pamphlet or book to guide them in what to meditate on during each set of beads. This unique idea eliminates the need for carrying a book with you by creating a set up beads that has the mysteries printed upon them.

### CROSS-REFERENCE TO RELATED APPPLICATIONS

60/487,233, FILING DATE: Jul. 16, 2003

### STATEMENT REGARDING FEDERALLY SPONSORED R&D

There is no federally sponsored research and development associated with this invention.

### REFERENCE TO SEQUENCE LISTING

Not applicable. No computer discs are included with this application.

### FIELD OF THE INVENTION

The present invention pertains to a creation of special and uniquely designed beads that are inserted into a standard rosary set of beads that teaches the prayer what to meditate on during prayer.

### BACKGROUND OF THE INVENTION

A well-known device for counting prayers is a strand of beads used during the recitation of the rosary in the Catholic religion. In order to learn how to correctly pray the rosary, you have to locate information (typically by finding and purchasing a leaflet on in the instructions) of what days to pray certain mysteries of the rosary. The beads, in and of themselves, do not help you to know what to meditate on during prayer. You have to remember the teachings or the information.

Therefore, there is a need in the art for a method that is inherent in the rosary beads themselves, to instruct what to meditate on, and when.

The originality of this invention is certain as the Pope only recently added the “Luminous Mysteries” to the Rosary in 2002. Never before did the ‘luminous mysteries’ exist, and no rosaries that have the mysteries printed on them exist, much less with the newly defined Luminous Mysteries.

### BRIEF SUMMARY OF THE INVENTION

This invention is simple, a novelty, unique of design and cannot be found in patent searches or in the art. One of the reasons for this is that the new addition of a set of mysteries to the rosary was added in 2002, the first change to the rosary in hundreds of years. This invention is the design of special beads that are inserted into the traditional rosary that instruct and remind the prayer of which meditation to pray on what days. The invention consists of 6 unique beads. Each bead has 4 faces if the design of the bead is a square. If the design of the bead is a tube, the following information is printed around the tube as shown in the figures included in this application.

### BRIEF DESCRIPTION OF THE DRAWINGS

The figures below show how the words are situated on each bead, and how the beads are inserted into a strand of beads. I've sent along a completed invention for your information, and to assist with any questions associated with the drawings. In summary, the beads are designed as follows:

The design of the lead bead has the following information on the four faces:
Face 1: Joyful: Mon, Sat
Face 2: Luminous: Thursday
Face 3: Sorrowful: Tues, Fri
Face 4: Glorious: Wed, Sun

The 1st bead has this on each of the four faces:
Face 1: J1: Annunciation
Face 2: L1: Baptism
Face 3: S1: Agony
Face 4: G1: Resurrection

The 2nd bead has this on each of the four faces:
Face 1: J2: Visitation
Face 2: L2: Wedding
Face 3: S2: Scourged
Face 4: G2: Ascension

The 3rd bead has this on each of the four faces:
Face 1: J3: Birth
Face 2: L3: Proclamation
Face 3: S3: Crowned Thorns
Face 4: G3: Holy Spirit

The 4th bead has this on each of the four faces:
Face 1: J4: Presentation
Face 2: L4: Transfiguration
Face 3: S4: Carries Cross
Face 4: G4: Assumption

The 5th bead has this on each of the four faces:
Face 1: J5: Finding Temple
Face 2: L5: Last Supper
Face 3: S5: Crucifixion
Face 4: G5: Coronation

### DESCRIPTION

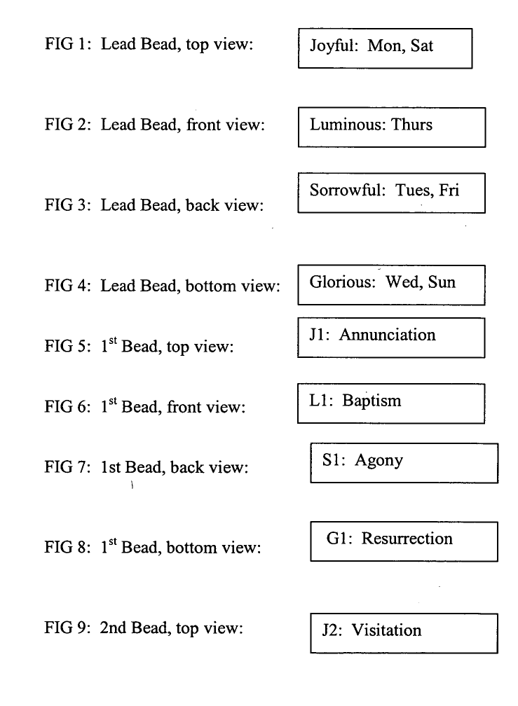

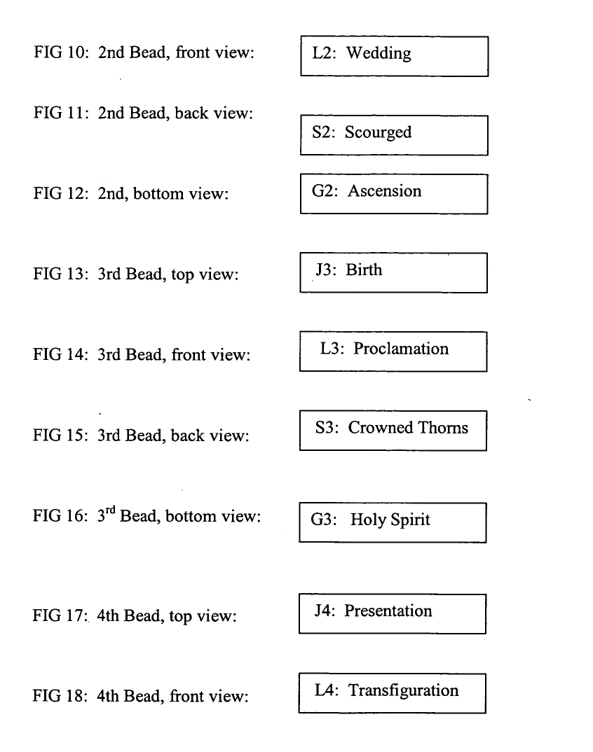

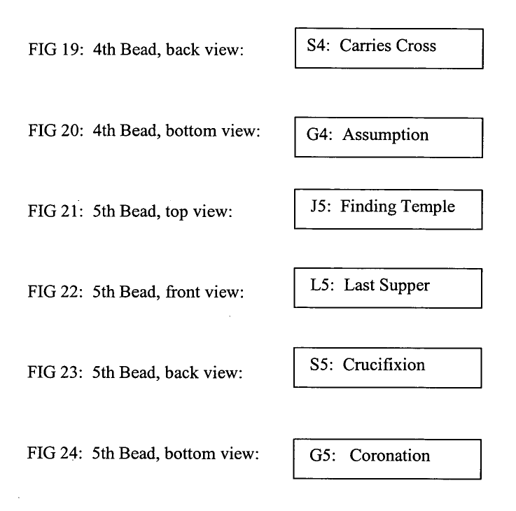

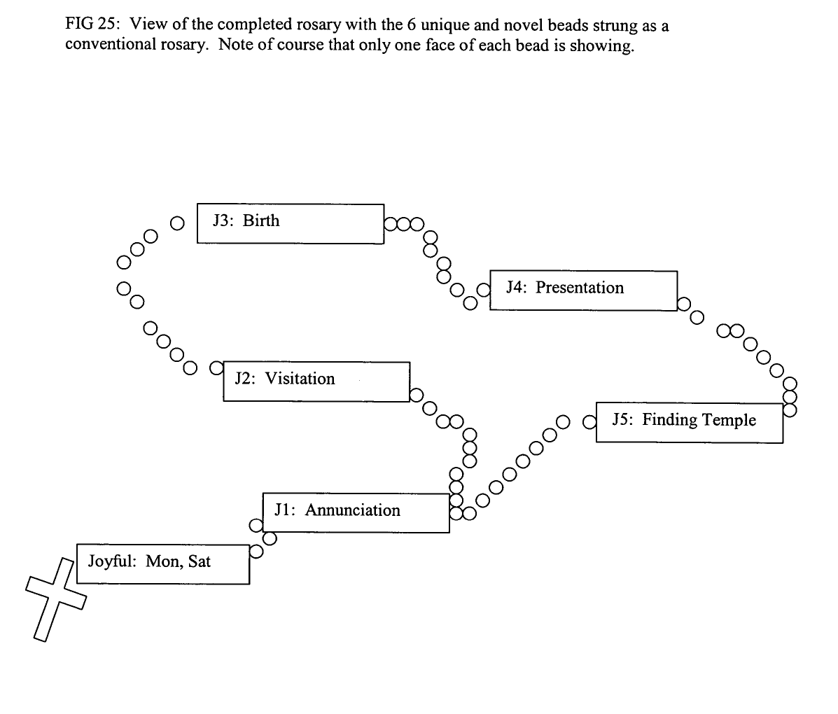

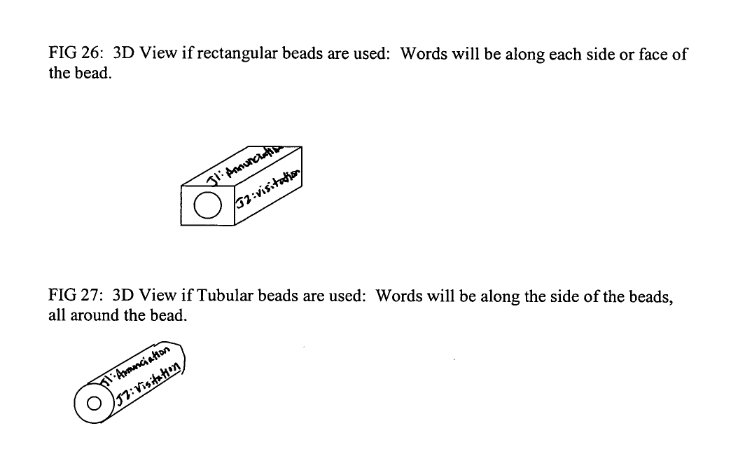

Once the beads are manufactured as described above, they are strung in the fashion of conventional rosary beads, with these unique beads replacing the 6 large beads in the rosary in the locations as shown in FIG. 25. The invention is for the beads as well as the completion in a strung set of beads.

1) A set of rosary beads used to teach what meditation prayers are to be recited on certain days of the week comprising:
a plurality of beads connected to one another such that the beads are able to rotate;
mystery and day of the week indicia located on each bead;
wherein a user can hold the rosary and each bead thereof and be informed as to the mystery to be recited and which day of the mystery should be recited.
